(19) United States
(12) Patent Application Publication
(10) Pub. No.: US 2026/0304324 A1
(43) Pub. Date: Oct. 1, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/699,659

(22) Filed: Jun. 5, 2026

Related U.S. Application Data
(63) Continuation of application No. PCT/CN2024/118507, filed on Sep. 12, 2024.

(51) Int. Cl. H04W 52/02; H04W 68/02

(52) U.S. Cl. CPC H04W 52/0235; H04W 68/02

(57) ABSTRACT

A method and apparatus for wireless communication are provided. One example method includes: receiving a first wake-up signal, wherein the first wake-up signal is used to wake up the second communications module; and determining, based on first information, a first paging occasion for performing paging detection, wherein the first wake-up signal is received by using the first communications module, the paging detection is performed by the second communications module, and the first information comprises a reception occasion of the first wake-up signal.

### CROSS-REFERENCE TO RELATED APPLICATIONS

This application is a continuation of International Application No. PCT/CN2024/118507, filed on Sep. 12, 2024, the disclosure of which is hereby incorporated by reference in its entirety.

### TECHNICAL FIELD

The present application relates to the field of communications technologies, and more specifically, to a method and apparatus for wireless communication.

### BACKGROUND

To reduce power consumption of a terminal device caused by periodically detecting paging messages, a low-power wake-up signal (low-power wake-up signal, LP-WUS) is introduced into some communications systems. For example, the terminal device may receive, by using a low-power wake-up module independent of a main communications module, an LP-WUS transmitted by a network device. In this case, how the terminal device performs paging detection based on the LP-WUS is required to be considered.

### SUMMARY

The present application provides a method and apparatus for wireless communication. Various aspects of embodiments of the present application are described below.

According to a first aspect, a method for wireless communication is provided. The method is applied to a first terminal device that includes a first communications module and a second communications module, and the method includes: receiving a first wake-up signal, where the first wake-up signal is used to wake up the second communications module; and determining, based on first information, a first paging occasion for performing paging detection, where the first wake-up signal is received by using the first communications module, the paging detection is performed by the second communications module, and the first information includes a reception occasion of the first wake-up signal and/or a load of a serving cell where the first terminal device is located.

According to a second aspect, a method for wireless communication is provided. The method includes: transmitting a first wake-up signal to a first terminal device, where the first wake-up signal is used to wake up a second communications module of the first terminal device; and determining, based on first information, a first paging occasion for transmitting a paging message to the first terminal device, where the first terminal device includes a first communications module and the second communications module, the first wake-up signal is received by using the first communications module, the paging message is detected by the second communications module, and the first information includes a reception occasion of the first wake-up signal and/or a load of a serving cell where the first terminal device is located.

According to a third aspect, an apparatus for wireless communication is provided. The apparatus is a first terminal device, and the apparatus includes: a first communications module, receiving a first wake-up signal, where the first wake-up signal is used to wake up a second communications module; and a second communications module, determining, based on first information, a first paging occasion for performing paging detection, where the first wake-up signal is received by using the first communications module, the paging detection is performed by the second communications module, and the first information includes a reception occasion of the first wake-up signal and/or a load of a serving cell where the first terminal device is located.

According to a fourth aspect, an apparatus for wireless communication is provided. The apparatus is a network device, and the apparatus includes: a transmitting module, transmitting a first wake-up signal to a first terminal device, where the first wake-up signal is used to wake up a second communications module of the first terminal device; and a determining module, determining, based on first information, a first paging occasion for transmitting a paging message to the first terminal device, where the first terminal device includes a first communications module and the second communications module, the first wake-up signal is received by using the first communications module, the paging message is detected by the second communications module, and the first information includes a reception occasion of the first wake-up signal and/or a load of a serving cell where the first terminal device is located.

According to a fifth aspect, a communications apparatus is provided. The communications apparatus includes a memory and a processor, where the memory is configured to store a program, and the processor is configured to invoke the program in the memory to execute the method according to the first aspect or the second aspect.

According to a sixth aspect, an apparatus is provided. The apparatus includes a processor configured to invoke a program from a memory to execute the method according to the first aspect or the second aspect.

According to a seventh aspect, a chip is provided. The chip includes a processor, invoking a program from a memory, to cause a device on which the chip is installed to execute the method according to the first aspect or the second aspect.

According to an eighth aspect, a computer-readable storage medium is provided. The computer-readable storage medium stores a program, and the program causes a computer to execute the method according to the first aspect or the second aspect.

According to a ninth aspect, a computer program product is provided. The computer program product includes a program, where the program causes a computer to execute the method according to the first aspect or the second aspect.

According to a tenth aspect, a computer program is provided, where the computer program causes a computer to execute the method according to the first aspect or the second aspect.

In embodiments of the present application, after receiving a first wake-up signal by using a first communications module, a first terminal device may determine, based on a reception occasion of the first wake-up signal and/or a load of a cell where the first terminal device is located, a first paging occasion for performing paging detection. It may be learned that the first paging occasion is not statically configured by a network device, but dynamically varies according to the reception occasion of the first wake-up signal or a current load. A dynamic paging occasion is configured, thereby facilitating paging any terminal device at any time within a paging period.

### BRIEF DESCRIPTION OF THE DRAWINGS

FIG. 1 shows a wireless communications system to which embodiments of the present application are applied.

FIG. 2 is a schematic diagram of a possible structure of a low-power wake-up module to which embodiments of the present application are applicable.

FIG. 3 is a schematic diagram of another possible structure of a low-power wake-up module to which embodiments of the present application are applicable.

FIG. 4 is a schematic diagram of still another possible structure of a low-power wake-up module to which embodiments of the present application are applicable.

FIG. 5 is a schematic flowchart of a method for wireless communication according to an embodiment of the present application.

FIG. 6 is a schematic diagram of a possible implementation of the method shown in FIG. 5.

FIG. 7 is a schematic structural diagram of an apparatus for wireless communication according to an embodiment of the present application.

FIG. 8 is a schematic structural diagram of another apparatus for wireless communication according to an embodiment of the present application.

FIG. 9 is a schematic structural diagram of a communications apparatus according to an embodiment of the present application.

### DETAILED DESCRIPTION OF THE EMBODIMENTS

The following describes the technical solutions in embodiments of the present application with reference to the accompanying drawings in embodiments of the present application. Apparently, the described embodiments are some rather than all of embodiments of the present application. All other embodiments obtained by persons of ordinary skill in the art based on the embodiments of the present application shall fall within the protection scope of the present application.

Embodiments of the present application may be applied to various communications systems. For example, embodiments of the present application may be applied to a global system for mobile communications (global system of mobile communication, GSM), time division multiple access (time division multiple access, TDMA), frequency division multiple access (frequency division multiple access, FDMA), orthogonal frequency division multiple access (orthogonal frequency division multiple access, OFDMA), single-carrier frequency division multiple access (single-carrier frequency division multiple access, SC-FDMA), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communications system. Embodiments of the present application may be further applied to another communications system and radio technologies, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to unlicensed spectrum. The unlicensed spectrum may also be considered as shared spectrum. Alternatively, the communications system in embodiments of the present application may be applied to licensed spectrum. The licensed spectrum may also be considered as dedicated spectrum.

Embodiments of the present application may be applied to a non-terrestrial network (non-terrestrial network, NTN) system. For example, the NTN system may be a 4G-based NTN system, an NR-based NTN system, an internet of things (internet of things, IoT)-based NTN system, or a narrow band-internet of things (narrow band internet of things, NB-IoT)-based NTN system.

The communications system may include one or more terminal devices. The terminal device in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like. It should be noted that a specific type of the terminal device is not limited in embodiments of the present application.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

In some embodiments, the terminal device may be a device that provides a user with voice and/or data connectivity. For example, the terminal device may be a handheld device, a vehicle-mounted device, or the like that has a wireless connection function. In some specific examples, the terminal device may be a mobile phone (mobile phone), a tablet computer (tablet personal computer), a personal computer (personal computer, PC), a laptop computer (laptop computer) or referred to as a notebook computer, a personal digital assistant (personal digital assistant, PDA), a palmtop computer, a netbook, an ultra-mobile personal computer (ultra-mobile personalcomputer, UMPC), a mobile internet device (mobile internet device, MID), a wearable device (wearable device), a robot, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), and terminal-side devices such as a vehicle-mounted device (vehicle UE, VUE), a pedestrian terminal (pedestrian UE, PUE), a smart home appliance (a home device having a wireless communication function, for example, a refrigerator, a television, a washing machine, or furniture), a game console, and a teller machine or a self-service machine.

In an example, a wearable device includes: a smart watch, a smart bracelet, a smart headset, smart glasses, smart jewelry (a smart wrist bangle, a smart wrist chain, a smart ring, a smart necklace, a smart ankle bangle, a smart ankle chain, and the like), a smart wristband, smart clothing, and the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may include one or more network devices. The network device in embodiments of the present application may be a device configured to communicate with the terminal device. The network device may also be referred to as an access network device, a radio access network device, a radio access network (radio access network, RAN), a radio access network function, or a radio access network unit. The network device in the embodiments of the present application may be a RAN node (or device) that connects the terminal device to a wireless network. The network device may be, for example, a base station, a WLAN access point, a Wi-Fi node, or the like. The network device may broadly cover various names below, or may be interchanged with names below, for example, a NodeB (NodeB), an evolved NodeB (evolved NodeB, eNB), a next-generation NodeB (next generation NodeB, gNB), a relay station, an access point (access point, AP), a base transceiver station (base transceiver station, BTS), a radio base station, a radio transceiver, a basic service set (basic service set, BSS), an extended service set (extended service set, ESS), a home B node, a home evolved B node, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a radio node, a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, or another appropriate term in the field, provided that a same technical effect is achieved. The base station is not limited to a specific technical word. For example, the base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in D2D, V2X, or M2M communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be stationary or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

By way of example rather than limitation, in embodiments of the present application, the network device may have a mobility characteristic. For example, the network device may be a mobile device. In some embodiments of the present application, the network device may be a satellite or a balloon station. In some embodiments of the present application, the network device may alternatively be a base station arranged on land, water, or the like.

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro base station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

For example, FIG. 1 is a schematic diagram of an architecture of a communications system according to an embodiment of the present application. As shown in FIG. 1, the communications system 100 may include a network device 110, and the network device 110 may be a device that communicates with a terminal device 120 (or referred to as a communications terminal or a terminal). The network device 110 may provide communication coverage in a specific geographic area, and may communicate with a terminal device located in the coverage.

FIG. 1 exemplarily shows one network device and two terminal devices. In some embodiments of the present application, the communications system 100 may include a plurality of network devices, and another quantity of terminal devices may be included within coverage of each network device. This is not limited herein.

In embodiments of the present application, a network-side device in the communications system may include an access network device or a core network device. For example, the communications system shown in FIG. 1 may further include other network entities such as a mobility management entity (mobility management entity, MME), or an access and mobility management function (access and mobility management function, AMF), which is not limited in embodiments of the present application.

It should be understood that a device having a communication function in a network/system in embodiments of the present application may be referred to as a communications device. The communications system 100 shown in FIG. 1 is used as an example. The communications device may include a network device 110 and a terminal device 120 that have a communication function. The network device 110 and the terminal device 120 may be specific devices described above. Details are not described herein again. The communications device may further include another device in the communications system 100, such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

With development of mobile communications technologies, application fields of the internet of things are gradually expanding. However, without support of an external power supply, a 5G internet of things device is difficult to implement in practice. This is because a 5G device in a cellular network consumes tens of milliwatts of power even when the 5G device does not transmit or receive any data. Such power consumption in the idle state is caused, because the 5G device is required to perform periodic measurement and detect potential paging messages.

To reduce power consumption of the terminal device, a low-power wake-up module and an LP-WUS are introduced into an NR system. The low-power wake-up module is also referred to as a low-power wake-up receiver (low-power wake-up receiver, LP-WUR) or low-power wake-up radio (low-power wake-up radio, LP-WUR). The receiver may also be referred to as a receiving unit. For example, when the terminal device is idle, the main communications module/receiver may be turned off or set to be in a deep sleep state, and an LP-WUS may be monitored only by using the LP-WUR, thereby reducing power consumption of the terminal device. The main communications module/receiver of the terminal device may also be referred to as main radio (main radio, MR). Accordingly, the low-power wake-up module may also be referred to as LR. When the MR is woken up, the terminal device may enter a radio resource control (radio resource control, RRC) connected state. The LP-WUR of the terminal device may remain being turned-on to receive an LP-WUS. Therefore, the LP-WUR may be independent of the 5G device, that is, the 5G device may be in an off state while the LP-WUR is in an active state and searching for a potential LP-WUS. To ensure low-power performance of the terminal device, the LP-WUR is required to be embedded in a related communications system (for example, an NR system).

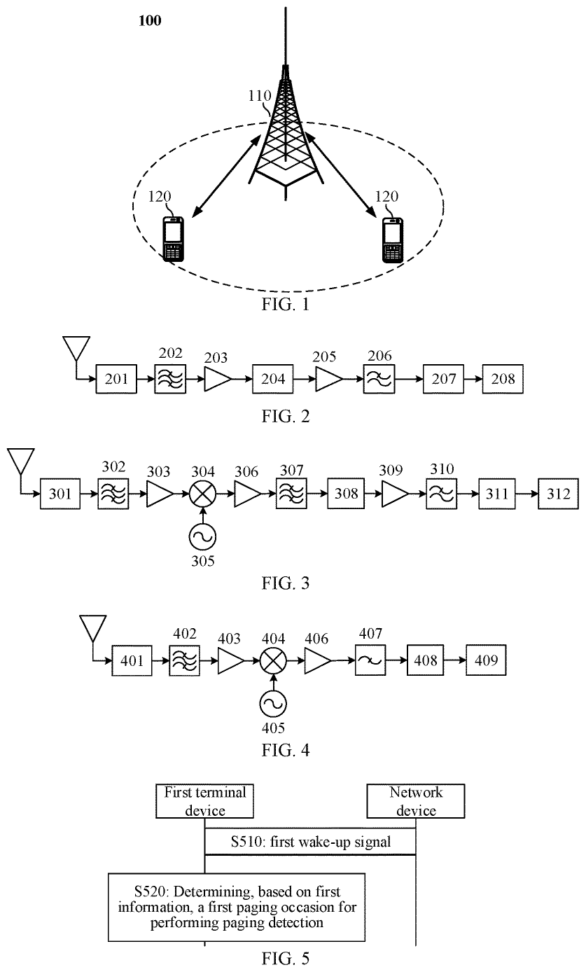

In some embodiments, the LP-WUR may support a bandwidth ranging from 5 MHz to 20 MHz. When the LP-WUR is embedded in a related communications system, the main communications module (or referred to as MR) and the low-power wake-up module (LP-WUR or LR) that are on the terminal device side may be two modules, or may be integrated into one module. The LP-WUR may support a plurality of receiver architectures. The following provides an exemplary description of the LP-WUR by using three receiver architectures shown in FIG. 2 to FIG. 4 as examples.

FIG. 2 is a schematic structural diagram of an LP-WUR based on radio frequency (radio frequency, RF) envelope detection (envelope detection). The receiver architecture shown in FIG. 2 includes a matching network (matching network) 201, an RF bandpass filter (bandpass filter, BPF) 202, an RF low noise amplifier (low noise amplifier, LNA) 203, an RF envelope detector (envelope detector) 204, baseband (baseband, BB) asymmetric processing (asymmetric processing, AMP) 205, a BB low pass filter (low pass filter, LPF) 206, a 1-bit or multi-bit (1-bit or multi-bit) analog-to-digital converter (analog-to-digital converter, ADC) 207, and digital BB processing (digital BB processing) 208.

In the architecture shown in FIG. 2, an RF signal is directly converted into a baseband signal through the RF envelope detector. Due to absence of a local oscillator (local oscillator, LO) and a phase-locked loop (phase-locked loop, PLL), relatively low power consumption may be implemented. Optionally, the architecture may include a 1-bit or multi-bit ADC, an RF LNA and/or a BB AMP, and a high-Q matching network and/or an RF BPF and/or a BB LPF. Optionally, to support a plurality of frequency bands and/or carriers, a plurality of high-Q matching networks and/or RF BPFs or a plurality of off-chip components may be required, thereby suppressing adjacent channel interference or interference from conventional NR signals on adjacent subcarriers and/or other LP-WUSs, and supporting frequency band and/or carrier tuning.

FIG. 3 is a schematic structural diagram of an LP-WUR having a heterodyne (heterodyne) architecture (architecture) based on intermediate frequency (intermediate frequency, IF) envelope detection. The receiver architecture shown in FIG. 3 includes a matching network 301, an RF BPF 302, an RF LNA 303, a mixer (mixer) 304, an LO 305, an IF AMP 306, an IF BPF 307, an IF envelope detector 308, a BB AMP 309, a BB LPF 310, a 1-bit or multi-bit ADC 311, and digital BB processing 312.

In the architecture shown in FIG. 3, an RF signal is converted into an intermediate frequency (IF) signal by using an RF mixer with an LO. The IF signal is converted into a baseband signal through IF envelope detection. Depending on design, there may be one or more intermediate frequency stages, thereby implementing lower power consumption by relaxing accuracy and stability requirements of the LO. A 1-bit or multi-bit ADC may be applied to the architecture. The high-Q matching network and/or the RF BPF and/or the IF BPF (and/or the BB LPF) may be used to suppress adjacent channel interference or interference from conventional NR signals on adjacent subcarriers and/or other LP-WUSs. Optionally, some components such as an RF LNA and/or an IF AMP and/or a BB AMP may be applied to the architecture, so as to improve sensitivity. Optionally, the architecture may achieve frequency band and/or carrier tuning by adjusting LO frequency.

FIG. 4 is a schematic structural diagram of an LP-WUR having a homodyne (homodyne) or zero intermediate frequency (zero-IF) architecture based on baseband (BB) envelope detection. The receiver architecture shown in FIG. 4 includes a matching network 401, an RF BPF 402, an RF LNA 403, a mixer (mixer) 404, an LO 405, a BB AMP 406, a BB LPF/BPF 407, a 1-bit or multi-bit ADC 408, and digital BB processing 409.

In the architecture shown in FIG. 4, frequency band and/or carrier tuning may be achieved by adjusting LO frequency. The BB BPF/LPF is used instead of the high-Q matching network and/or the RF BPF, thereby more efficiently and simply suppressing adjacent channel interference or interference from conventional NR signals on adjacent subcarriers and/or other LP-WUSs. The RF LNA may be applied to improve sensitivity. Baseband envelope detection (not shown in FIG. 4) may be completed in an analog domain (before conversion by the ADC) or in a digital domain (after conversion by the ADC).

For the design architecture of the LP-WUR, the LP-WUS may be deployed only in some frequency bands/carriers. For the terminal device, deploying the LP-WUS only in some frequency bands/operators is beneficial to reduce costs of the LP-WUR. Due to a limited dynamic range of the terminal device, different frequency bands may be supported by different RF modules (such as the RF filters, LNAs, and oscillators shown in FIG. 2 to FIG. 4), and limited frequency bands may reduce costs. For the network side, deploying the LP-WUS only in some frequency bands/carriers is beneficial to reduce system overheads. Therefore, it is beneficial to allow a quantity of frequency bands/carriers supported by the LP-WUR to be less than a quantity of frequency bands/carriers supported by the MR.

In some embodiments, for the terminal device in an idle/inactive mode, cell reselection of the terminal device is not controlled by a network device (for example, a gNB). Therefore, the terminal device may freely select a frequency band/carrier in which the terminal device resides.

A plurality of LP-WUR architectures are described above with reference to FIG. 2 to FIG. 4. All LP-WUR architectures may be applied to on-off keying (on-off keying, OOK) modulation. Some of these architectures may also be applied to other modulation, such as frequency-shift keying (frequency-shift keying, FSK).

OOK is a well-known modulation scheme. OOK may be implemented by a low-power receiver, for example, via envelope/energy detection. OOK is a special case of amplitude shift keying (amplitude shift keying, ASK). OOK has only two amplitudes: ON and OFF. When applied to a multi-carrier (multi-carrier, MC) system such as an orthogonal frequency division multiplexing (orthogonal frequency division multiple, OFDM) system, OOK is also referred to as multi-carrier OOK, because ON and OFF signals usually span a plurality of subcarriers.

In some embodiments, in an OFDM-based MC-OOK system, a network node may perform multi-carrier amplitude shift keying (MC-ASK) waveform generation using encoded bits, thereby generating a low-power wake-up signal (LP-WUS).

The foregoing describes a plurality of LP-WUR architectures and LP-WUS generation methods. When the network device transmits an LP-WUS, how the LP-WUR in the terminal device receives the LP-WUS and performs paging detection is required to be addressed.

In an example, when the terminal device performs paging detection based on the LP-WUS mechanism, how to determine a paging occasion for performing paging detection is required to be considered. For example, whether determination of the paging occasion is required to be associated with a reception occasion of the LP-WUS and how to associate the paging occasion with the reception occasion of the LP-WUS are required to be further studied.

Based on this, embodiments of the present application provide a method for wireless communication. According to the method, after receiving a first wake-up signal, a terminal device (for example, a UE) may determine, based on a reception occasion of the first wake-up signal and/or a load of a cell in which the terminal device is located, a paging occasion for performing paging detection. It may be learned that, according to the method for wireless communication provided in the embodiments of the present application, a dynamically configured paging occasion is used, so as to improve paging efficiency.

For ease of understanding, the following describes in detail the method provided in embodiments of the present application with reference to FIG. 5. FIG. 5 is described from a perspective of interaction between the first terminal device and the network device.

The first terminal device is any communications terminal that may receive a wake-up signal, and is not limited herein. In some embodiments, the first terminal device may be in an idle state or an inactive state. For example, the first terminal device may be a UE in an RRC idle (RRC_IDLE) mode/an RRC inactive (RRC_INACTIVE) mode. In some embodiments, the first terminal device may be in a connected state (CONNECTED).

In some embodiments, the first terminal device is a communications terminal in the internet of things. A serving cell of the terminal device may be an NTN cell, or may be a terrestrial network (terrestrial network, TN) cell.

The first terminal device may include the first communications module and the second communications module. For example, the first terminal device may include two communications modules that are independent of each other, to save power consumption. The first communications module being independent of the second communications module may also be considered as being independent of the first terminal device. For example, the first communications module and the second communications module in the first terminal device may be integrated together, but operating states and/or off states of the two communications modules may be set independently.

In an example, the first communications module and the second communications module may be in different states, respectively. For example, when the second communications module is in an off state, the first communications module may be in an active state for searching for a wake-up signal.

In some embodiments, the first communications module and the second communications module perform different functions, so as to reduce power consumption of the first terminal device. The first communications module receives the first wake-up signal used to wake up the second communications module, and the second communications module is configured to perform paging detection.

In an example, the first communications module is a low-power signal receiving module, and the second communications module is the main communications module of the first terminal device. For example, the first communications module belongs to the LP-WUR, and the second communications module belongs to the MR. For another example, the first communications module is a low-power wake-up receiver (wake-up receiver, WUR), and the second communications module is the MR.

In an example, the first communications module may use any of the receiver architectures described above, for example, any of the receiver architectures shown in FIG. 2 to FIG. 4.

In some embodiments, the first terminal device may include the LP-WUR described above or a module having a similar function, to monitor the LP-WUS. A module that monitors the LP-WUS is the first communications module.

In some embodiments, the first terminal device may be one in any terminal device group or subgroup.

In some embodiments, the first terminal device may be one in any terminal device group or subgroup. In an example, the first terminal device may be any terminal device in a first terminal device subgroup. That is, in a case that the first terminal device subgroup includes a plurality of terminal devices, the first terminal device may be one of the plurality of terminal devices. In an example, the first terminal device may be any terminal device in a first terminal device group. The first terminal device group may be divided into a plurality of terminal device subgroups. The first terminal device subgroup to which the first terminal device belongs may be configured, or dynamically changed.

In an example, the first terminal device group may be some or all of terminal devices within an area that are in an idle state or an inactive state. A plurality of terminal devices in the first terminal device group may be classified based on different characteristics to generate a plurality of device subgroups, which is not limited herein.

For example, the plurality of terminal device subgroups may be determined based on a wake-up delay of the main communications module of the terminal device. For example, the plurality of terminal device subgroups may alternatively be determined based on a service type or service priority of the terminal device.

The network device may provide service to the cell where the first terminal device is located. The network device may be any of the network devices or core network devices described above, which is not limited herein. For example, the network device may be any of the base stations described above.

In some embodiments, the serving cell where the first terminal device is located is a cell or a micro cell that can be served by the network device, which is not limited herein.

In some embodiments, the network device may be a communications device that supports the LP-WUS function. For example, the network device may periodically transmit an LP-WUS to facilitate waking up the terminal device. For example, the network device may implement a power-saving configuration that associates the LP-WUS with the PO.

In an example, a cell served by the network device is an NTN cell. For example, the network device may be a satellite in the NTN that covers an area where the terminal device is located, or may be a ground gateway or a terrestrial network device in the NTN that communicates with a satellite.

In some embodiments, the terminal device and the network device may be defined relative to each other. For example, relative to the network device, a relay device may also be referred to as a terminal device. For example, relative to the terminal device, a relay device may also be referred to as a network device.

In some embodiments, the network device may transmit a paging message to all terminal devices in the serving cell. In a case that the network device is an access network device such as a base station, the network device may directly transmit a paging message, or may receive a paging message from a core network. In a case that the network device is a core network device, the network device may transmit a paging message to an access network device, so that the access network device transmits a paging message to the terminal device.

Referring to FIG. 5, in Step S510, the first terminal device receives the first wake-up signal transmitted by the network device. The first wake-up signal may be the LP-WUS described above or a signal having a function similar to that of the LP-WUS. For brevity, the following uses the LP-WUS as an example for description.

In some embodiments, the first wake-up signal is one LP-WUS. One LP-WUS may be used to indicate whether to wake up one or more terminal devices. A plurality of terminal devices woken up by one LP-WUS belong to a terminal device group or a terminal device subgroup.

In an example, the first wake-up signal may be used for all of terminal devices in the first terminal device subgroup.

The first terminal device may receive the first wake-up signal by using the first communications module. Therefore, the first communications module is in an active state. In some embodiments, the first communications module may be configured only to receive the first wake-up signal, thereby reducing power consumption of the first terminal device.

The first wake-up signal is a wake-up signal that corresponds to the first terminal device, that is, the first wake-up signal may be used to indicate whether to wake up the first terminal device or some of modules in the first terminal device. The first terminal device or some of modules in the first terminal device being woken up may refer to that the communications module is switched from the off state to the active state, or may refer to that the communications module is triggered to perform paging detection (or monitoring).

The first wake-up signal is used to wake up the second communications module in the first terminal device. It should be understood that, because the first communications module may be independent of the first terminal device, the second communications module being woken up may also be referred to as the first terminal device being woken up. Before the first wake-up signal is received, the second communications module is in the off state. The first terminal device may determine, based on the first wake-up signal, whether to wake up the second communications module. In some embodiments, the first wake-up signal may be further used to wake up a module other than the second communications module in the first terminal device.

In some embodiments, in a case that the first wake-up signal indicates that the first terminal device is required to be woken up, the first wake-up signal may be used to wake up a communications module of the first terminal device that performs paging detection. For example, the first wake-up signal is used to wake up the main communications module that performs paging detection.

The first terminal device may receive the first wake-up signal in a first occasion. That is, the first occasion is a reception occasion of the first wake-up signal. The network device may transmit the first wake-up signal in the first occasion or a time domain location corresponding to the first occasion. The time domain corresponding to the first occasion is mainly for a scenario with a relatively long communication delay. The first occasion may be one of a plurality of occasions for receiving/detecting an LP-WUS.

Optionally, the first occasion may be one or more wake-up occasions (LP-WUS occasion, LO), or may be one or more monitoring occasions (monitor occasion, MO). The wake-up occasion may also be referred to as an LP-WUS occasion. The monitoring occasion may also be referred to as an LP-WUS monitoring occasion.

Optionally, the first occasion may be an occasion used by the first terminal device to detect the LP-WUS in a plurality of occasions, or may be one of a plurality of occasions used by the first terminal device to detect the LP-WUS.

The first terminal device receives the first wake-up signal in the first occasion for performing paging detection. In a case that the first occasion is a wake-up occasion/monitoring occasion, the first terminal device may perform paging detection in a paging occasion (paging occasion, PO) after the first occasion. Therefore, periodic configuration of wake-up occasions/monitoring occasions may be determined in conjunction with a discontinuous reception (discontinuous reception, DRX) mechanism associated with POs.

In some embodiments, the paging occasion may be a set of monitoring opportunities of a physical downlink control channel (physical downlink control channel, PDCCH). The paging occasion may consist of a plurality of slots (slot).

In an example, one paging occasion may include S synchronization signal block (synchronization signal block, SSB) beams. Paging (paging) messages transmitted on different SSB beams may be identical to or different from each other. S may be indicated by using a system information block (system information block, SIB). For example, S may be indicated or determined by using ssb-PositionsInBurst in an SIB1 message.

It should be understood that, in embodiments of the present application, an SSB may alternatively represent a synchronization signal/physical broadcast channel block (synchronization signal and physical broadcast channel block).

In some embodiments, in a case that a period of wake-up occasions/monitoring occasions may be configured independently of a DRX period, a plurality of wake-up occasions/monitoring occasions may be mapped to a single paging occasion. In this scenario, more frequent LP-WUS monitoring opportunities may be allowed to be configured while maintaining the same DRX period. That is, the terminal device may receive an LP-WUS more frequently without reducing the DRX period.

In some embodiments, after receiving the first wake-up signal, the first terminal device is required to wake up the second communications module to perform paging detection. In consideration of wake-up time of the second communications module, a paging occasion for the first terminal device may not be near a specific wake-up occasion/monitoring occasion (the first occasion), but the wake-up occasion/monitoring occasion may be used to trigger the first terminal device to monitor a paging occasion.

In an example, wake-up time of the terminal device may also be referred to as a wake-up delay or wake-up duration. Different terminal devices may have different wake-up time, depending on hardware characteristics, power optimization strategies, network conditions, design objectives of terminal devices themselves, and the like. For example, different terminal devices have processors of different speeds, resulting in differences in wake-up time: a high-performance processor may enter an active state faster than a low-performance processor. For example, speeds of a memory and a storage also affect wake-up time: a high-speed memory may accelerate recovery from a low-power state. For example, some terminal devices may use more stringent battery management strategies to prolong battery life, which may result in longer wake-up time. For example, different terminal devices may support different levels of low-power modes, and more time may be consumed for wake-up in a deeper low-power mode (for example, longer sleep time). For example, a base station (an eNB or a gNB) may configure different wake-up time and DRX periods for different terminal devices based on a network load and coverage. In areas with weak signals, the terminal device may consume more time for signal synchronization and recovery, resulting in longer wake-up time.

In Step S520, the first terminal device determines, based on first information, a first paging occasion for performing paging detection, namely a first PO. Accordingly, the network device may also determine, based on the same first information, the first paging occasion or a time domain location corresponding to the first paging occasion. That is, due to a transmission delay, there may be an offset between a time domain location of a paging occasion in which the network device transmits a paging message and a time domain location of a paging occasion in which the terminal device side receives the paging message.

The first terminal device performs paging detection to receive a paging message transmitted by the network device. It should be noted that the first terminal device determining the first paging occasion may include determining a time domain location or an index of the first paging occasion, or may include determining a time domain range of the first paging occasion.

In some embodiments, the first paging occasion may be a dynamically allocated paging occasion, so as to facilitate paging the terminal device in a timely manner. For example, in a case that the period of wake-up occasions/monitoring occasions may be configured independently of the DRX period, the network device may dynamically allocate paging occasions. For example, in consideration of the wake-up time of the second communications module, the reception occasion of the first wake-up signal may trigger the first terminal device to monitor a dynamic paging occasion. For example, a paging occasion corresponding to the first terminal device is dynamically changed.

It should be understood that, in embodiments of the present application, the serving cell where the first terminal device is located may also include a statically configured paging occasion. The statically configured paging occasion may be, for example, a paging occasion determined according to a calculation formula defined in a related protocol.

In some embodiments, the serving cell where the first terminal device is located may provide only a dynamically allocated paging occasion. For example, in a serving cell of some small-sized communications systems or local communications systems, the network device may configure only a dynamic paging occasion to facilitate paging the terminal device at any time. In these systems, the terminal device may perform paging detection in the dynamic paging occasion.

In some embodiments, the serving cell where the first terminal device is located may provide both a dynamically allocated paging occasion and a statically configured paging occasion to satisfy paging requirements for different types of terminal devices or different types of services. That is, within the serving cell, the network device configures both a conventional paging occasion and a dynamic paging occasion. To implement such a configuration, the network device may also configure a wake-up occasion/monitoring occasion for triggering the terminal device to monitor a conventional paging occasion and a wake-up occasion/monitoring occasion for triggering the terminal device to monitor a dynamic paging occasion.

In an example, in a scenario where the serving cell provides both a conventional paging occasion and a dynamic paging occasion, in addition to configuring, for the first terminal device, a conventional paging occasion (which may also be referred to as a conventional paging occasion) determined based on an identity (identity, ID) of the terminal device, the network device may configure, for the first terminal device, a dynamic paging occasion determined based on the reception occasion (for example, a monitoring occasion) of the wake-up signal.

In a scenario where the serving cell provides a dynamic paging occasion, by utilizing the dynamic paging occasion, the first terminal device can effectively receive the first wake-up signal and monitor the first paging occasion while minimizing unnecessary wake-up delay. In addition, any terminal device can be essentially paged at any time within a paging period by using the dynamic paging occasion.

In an example, in a case that a RAN directly transmits a paging message, and once the first terminal device wakes up the MR (the second communications module) to support a dynamic paging occasion, the RAN may transmit a paging message a plurality of times in a plurality of paging occasions within a paging period, so that the terminal device receives the paging message in a timely manner.

In an example, in a case that the RAN transmits a paging message to the terminal device based on a paging message transmitted from the core network, the core network is required to transmit a paging message to the RAN a plurality of times in a plurality of paging occasions within a paging period to enable a dynamic paging occasion.

The first terminal device may determine the first paging occasion based on the first information. The first information may include the reception occasion of the first wake-up signal and/or the load of the serving cell where the first terminal device is located. It should be understood that, the first information may further include other information related to paging.

In some embodiments, in a case that the first information includes the reception occasion of the first wake-up signal, the first terminal device may determine the first paging occasion directly based on the reception occasion, or may determine the first paging occasion in conjunction with other information. The other information is, for example, a configured parameter of a paging occasion.

In an example, the first paging occasion may be determined based on the reception occasion of the first wake-up signal and a first paging time window (paging time window, PTW). The first terminal device may determine the first PTW based on configuration provided by the network device. In an implementation, the first PTW may be the nearest PTW corresponding to the first terminal device relative to a current instant.

In an example, the first terminal device may determine a time domain range of the first paging occasion based on a location relationship between the reception occasion of the first wake-up signal and the first PTW. The first terminal device may perform paging detection within this time domain range.

In an implementation, in a case that the reception occasion of the first wake-up signal is before the first PTW, the first paging occasion is within the first PTW. For example, after receiving the wake-up signal before the first PTW, the first terminal device may monitor a paging occasion within the first PTW. For another example, the first wake-up signal may be monitored outside the PTW. After receiving the LP-WUS, the terminal device may monitor a paging occasion in a next PTW. That is, the terminal device may detect a paging occasion within an immediately following PTW to ensure timeliness of services of the terminal device.

In an implementation, in a case that the reception occasion of the first wake-up signal is within the first PTW, the first paging occasion is within the first PTW or a second PTW, where the second PTW is a next time window adjacent to the first PTW. For example, the first wake-up signal may be monitored within the first PTW. After receiving the first wake-up signal within the first PTW, the first terminal device may determine the time domain range of the first paging occasion based on wake-up time or switching time of the first terminal device.

In some scenarios, even if the first wake-up signal may be transmitted and received (within the first PTW) immediately after a paging message arrives, due to relatively long switching time, the first terminal device may be required to wait for a next PTW (the second PTW) to detect a PO. In other words, since remaining time in the first PTW is shorter than the switching time, the first paging occasion is within the second PTW.

In some scenarios, the first wake-up signal and the first paging occasion may be located within a same PTW. For example, after the first terminal device receives the first wake-up signal within the first PTW, and if the remaining time in the first PTW is greater than the switching time, the first paging occasion may be detected within the first PTW.

In an implementation, the first terminal device may detect the first wake-up signal before the first PTW and within the first PTW, so as to wake up the second communications module in a timely manner for paging detection.

In some embodiments, the first information may be used for determining a first paging frame (paging frame, PF) in which the first paging occasion is located. In an example, after the first paging frame is determined, the first terminal device may further determine the first paging occasion. In an example, after the first paging frame is determined, the first terminal device may monitor the first paging occasion within the first paging frame.

In an embodiment, the first paging frame may belong to a first type of paging frame. The first type of paging frame may be a dynamic paging frame. That is, the first type of paging frame is not a paging frame pre-configured by the network device, but is determined based on parameters such as arrival time of a paging message, transmission/reception time of a wake-up signal, and wake-up time of a terminal device.

In an example, in a case that the first information includes the reception occasion of the first wake-up signal, the first paging frame may be determined based on a system frame corresponding to the reception occasion of the first wake-up signal. For example, the first terminal device may determine the paging frame based on a frame within which the first wake-up signal is received, thereby enabling use of a dynamic paging occasion.

In an embodiment, the first paging occasion may belong to a first type of paging occasion. The first type of paging occasion may be a dynamic paging occasion. A static paging occasion corresponding to the first paging occasion may belong to a second type of paging occasion.

In an example, in a case that the first information includes the reception occasion of the first wake-up signal, the first paging occasion may be determined based on a slot corresponding to the reception occasion of the first wake-up signal. That is, the reception occasion of the first wake-up signal may be directly used for determining the first paging occasion.

In an embodiment, the first paging frame may belong to a second type of paging frame. A quantity of paging occasions included in the second type of paging frame may be changed dynamically. For example, in a case that the first information includes a load status of the serving cell where the first terminal device is located, the quantity of paging occasions included in the second type of paging frame may be dynamically changed according to the load status. For example, the quantity of paging occasions included in the second type of paging frame is determined based on a load of the serving cell within a first time period. The index of the first paging occasion is determined based on a quantity of paging occasions included in the first paging frame.

In an example, the first time period may be determined based on a higher-layer instruction. In an example, the first time period may be one or more frames, one or more subframes, or one or more slots.

Optionally, dynamic paging frames belonging to the first type of paging frame and the second type of paging frame may be determined according to an existing calculation formula for paging frames, with a dynamic offset introduced. For example, during calculation of a system frame number (system frame number, SFN) of a dynamic paging frame, a dynamic PO offset (DPO_{offset}) may be introduced based on the ID of the terminal device (UE_{ID}). DPO_{offset} may be determined based on a lower limit of the system frame number SFN_{LO} that is determined based on the first occasion and a ramp-up (ramp-up) offset (RU_{offset}) of the MR. Optionally, the lower limit of SFN_{LO} may be expressed as (SFN−SFN_{LO}−RU_{offset})×(N div T), where N denotes a quantity of paging frames within one paging period T.

In an embodiment, the first paging frame may alternatively belong to a third type of paging frame. The third type of paging frame is determined based on static configuration of the serving cell. Although the third type of paging frame may be a statically configured paging frame, a paging occasion in the paging frame may be dynamically configured. For example, a location of a paging occasion in the third type of paging frame may be dynamically changed. For another example, in a case that the first paging frame belongs to the third type of paging frame, an actual quantity of paging occasions in the first paging frame may be determined based on an adjustment factor δ. That is, a quantity of paging occasions pre-configured by the network device for the first paging frame remains unchanged, but in practice, the network device may dynamically adjust an actual quantity of paging occasions in the first paging frame based on the load of the cell.

It may be learned from the foregoing embodiment that, in embodiments of the present application, a paging frame type of the first paging frame belongs may be any one of the first type of paging frame, the second type of paging frame, or the third type of paging frame. The first terminal device may determine a type of the first paging frame based on the first information, and then determine the first paging occasion based on the determined type. Detailed descriptions will be given below with reference to three embodiments.

In some embodiments, in a case that the first information includes the load of the serving cell where the first terminal device is located, a current load status of the serving cell may be used for determining the index of the first paging occasion. The load of the serving cell is related to one or more of the following information: a maximum quantity of paging requests for the serving cell; a current quantity of paging requests for the serving cell; or a service type of the serving cell.

In an example, the maximum quantity of paging requests of the serving cell may include a maximum quantity of paging requests that the serving cell can support. The maximum quantity of paging requests may include a paging request from the core network, and may also include a paging request of the RAN itself.

In an example, the current quantity of paging requests for the serving cell may refer to a quantity of paging requests for the serving cell within a current paging period. The quantity of paging requests may include a paging request from the core network, and may also include a paging request from the RAN itself.

In an example, the service type of the serving cell may be used as one of references for the load of the serving cell. For example, in a case that a quantity of high-priority service types in the serving cell increases, the load of the serving cell also increases.

In an example, the load of the serving cell may be classified into a high load and a low load, to calculate a quantity of paging occasions in one paging frame under different loads. Assuming that each paging frame initially includes Ns paging occasions (Ns≥1), the quantity of paging occasions in the paging frame may be increased under the high load and may be reduced under the low load. Increasing the quantity of paging occasions in the paging frame under the high load may help distribute paging requests. Reducing the quantity of paging occasions in the paging frame under the low load may reduce unnecessary power consumption. It may be learned from the foregoing description that, the paging frame in which the quantity of paging occasions included may be dynamically adjusted is the second type of paging frame.

For example, the load of the serving cell may be determined based on a network load coefficient L. For example, if L is set to be greater than 50%, it indicates a high-load scenario. If L is set to be less than or equal to 50%, it indicates a low-load scenario. In a case that an initial quantity of paging occasions in a paging frame is Ns, a quantity Ns_{high}′ of paging occasions under the high load and a quantity Ns_{low}′ of paging occasions under the low load may be respectively expressed as follows:

$${Ns}_{high}^{′} = Ns + ⌊ Ns \times L ⌋ ; and$$

$${Ns}_{low}^{′} = Ns - ⌊ Ns \times ( 1 - L ) ⌋ .$$

In an implementation, the network load coefficient L may be related to a quantity of paging requests. L may denote a quotient obtained when the current quantity of paging requests for the serving cell is divided by the maximum quantity of paging requests for the serving cell, that is, L=Current quantity of paging requests/Maximum quantity of paging requests.

In another implementation, L may be another value representing the load of the serving cell. This value is set based on a specific coverage status of the network device.

Optionally, the adjustment factor δ described above may have a correspondence with the load coefficient L. δ may be less than 1, greater than 1, or equal to 1. However, L can only be less than or equal to 1.

In the foregoing embodiment, the network device may dynamically adjust a quantity of paging occasions in each paging frame. This dynamic adjustment mechanism ensures that the network can effectively process more paging requests under the high load, while optimizing power consumption of the terminal device under the low load.

In some embodiments, the first information may further include the wake-up time of the first terminal device or switching time of the second communications module. That is, when the first terminal device receives the first wake-up signal and determines the first paging occasion, switching time for the first terminal device to switch from monitoring a wake-up signal to monitoring a paging message is also required to be considered. The switching time may alternatively be time for waking up the second communications module to perform paging detection.

Optionally, the switching time of the second communications module may include transition time (transition time) for processing the first wake-up signal, ramp-up of the second communications module from an ultra-deep sleep state, and cell reselection/synchronization.

In an example, the first paging occasion may be determined based on the reception occasion of the first wake-up signal and the switching time of the second communications module.

In an example, the first information includes the switching time of the second communications module, and the first paging occasion may be one of a plurality of paging occasions. The plurality of paging occasions may be located after a first time domain location. The first time domain location is determined based on the reception occasion of the first wake-up signal and the switching time.

In the example described above, the plurality of paging occasions may be one or more existing paging occasions defined by the network device, but these existing paging occasions are located after the switching time of the second communications module. It should be noted that the switching time of the second communications module may also be referred to as switching time of the first terminal device. The switching time may refer to time when the first terminal device starts performing paging detection.

In the example described above, the first time domain location T1 of the first paging occasion is a sum of the reception occasion T0 of the first wake-up signal and the switching time t, that is, T1=T0+t.

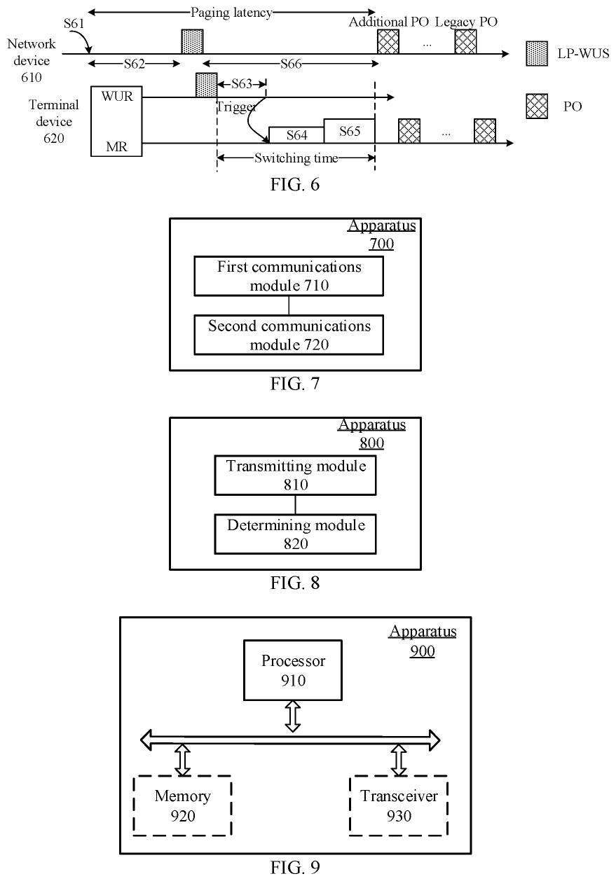

For ease of understanding, an impact of the switching time of the second communications module on the first paging occasion is schematically described below with reference to FIG. 6. FIG. 6 primarily describes processing procedures of each of a network device 610 and a terminal device 620. A first communications module included in the terminal device 620 is a WUR, and a second communications module is MR. A wake-up signal used to wake up the terminal device 600 is an LP-WUS. A dynamic paging occasion configured by the network device 610 for the terminal device 620 includes an additional paging occasion (additional PO) and a legacy paging occasion (legacy PO).

Referring to FIG. 6, in Step S61, the network device 610 receives a paging message from a core network, that is, paging arrived (paging arrived).

In Step S62, the network device 610 waits for a monitoring occasion for a wake-up signal to transmit an LP-WUS (waiting for LP-WUS MO).

In Step S63, after the WUR of the terminal device 620 receives the LP-WUS, the WUR executes a wake-up signal processing procedure (LP-WUS processing). Upon completion of Step S63, a wake-up process and a synchronization process of the MR are triggered (triggering).

In Step S64, the MR of the terminal device 620 executes ramp-up during the wake-up process.

In Step S65, the MR of the terminal device 620 performs a synchronization (sync) or re-synchronization (re-sync) process.

In Step S66, the network device 610 transmits a paging message in a paging occasion after the MR completes synchronization (Step S65) (transmit paging in the PO after sync).

It may be learned from FIG. 6 that, for the network device 610, duration between a time instant of arrival of the paging message in S61 and a time instant in the paging occasion when the paging message is transmitted is paging latency (paging latency). For the terminal device 620, the switching time includes the three procedures from Step S63 to Step S65. When the MR is ready for paging monitoring after synchronization/re-synchronization, the terminal device 620 may immediately monitor a dynamic paging occasion. Accordingly, the network device 610 may transmit a paging message in the dynamic paging occasion to reduce the latency.

A plurality of methods for determining the dynamic paging occasion (the first paging occasion) is described above with reference to FIG. 5 and FIG. 6. In these methods, the paging frame where the first paging occasion is located may belong to any of the three types of paging frames. The following provides exemplary descriptions of methods for determining the first paging occasion based on the three types of paging frames with reference to three embodiments, respectively.

The first paging frame in Embodiment 1 belongs to the first type of paging frame. The system frame number of the first paging frame may be determined based on a frame number of the system frame corresponding to the reception occasion of the first wake-up signal. The system frame number of the first paging frame may alternatively be determined based on a quantity of frames corresponding to the switching time of the second communications module (or the first terminal device).

In an example, the frame number of the first paging frame may be a sum of the frame number of the system frame in which the first terminal device receives the first wake-up signal and the quantity of frames corresponding to the switching time of the second communications module.

The first paging frame in Embodiment 2 belongs to the second type of paging frame. A quantity of paging occasions included in the second type of paging frame may be dynamically changed. In this embodiment, the second type of paging frame may be determined based on a method for a conventional paging frame, except that a quantity of paging occasions in the paging frame varies with changes in a load status of the serving cell. The quantity of paging occasions dynamically adjusted based on the load factor Lis Ns′.

In an example, the system frame number SFN of the first paging frame meets a formula (SFN+PF_{offset}) mod T=(T div N)×(UE_{ID} mod N), where T denotes a paging period, and T=min (a default paging period, a UE-specific DRX period); N denotes a quantity of paging frames included within one T, and one paging frame consists of a plurality of paging occasions; PF_{offset} denotes a frame offset of the PF; and UE_{ID} denotes the ID of the first terminal device.

In an example, the quantity of paging occasions in the first paging frame is Ns′ described above. In a case that a current load of the serving cell is high, Ns′=Ns_{high}′. In a case that a current load of the serving cell is low, Ns′=Ns_{low}′.

In an example, the index iₛ of the first paging occasion is:

$${i}_{s} = floor ( {UE}_{ID} / N ) mod {Ns}^{′} .$$

In which, UE_{ID} denotes an identity of the first terminal device, N denotes a quantity of paging frames within one period, and Ns′ denotes the quantity of paging occasions included in the first paging frame.

The first paging frame in Embodiment 3 belongs to the third type of paging frame. The third type of paging frame is a paging frame statically configured by the network device. Therefore, the system frame number of the first paging frame may be determined in the manner in Embodiment 2.

In an example, an actual quantity of paging occasions in the third type of paging frame is related to the adjustment factor δ. For example, in a case that an initial quantity of paging occasions is Ns, one paging frame belonging to the third type of paging frame may include δ×Ns paging occasions. The adjustment factor δ is a rational number and may vary with a change of a current load of the cell or may vary depending on a service type.

In an example, the index iₛ of the first paging occasion may be expressed as:

$${i}_{s} = floor ( {UE}_{ID} / N ) mod ( δ \times Ns ) .$$

In which, UE_{ID} denotes an identity of the first terminal device, N denotes a quantity of paging frames within one period, Ns denotes a quantity of paging occasions in the third type of paging frame, and δ denotes an adjustment factor related to the load of the serving cell.

The foregoing describes the method embodiments of the present application in detail with reference to FIG. 1 to FIG. 6. The following describes in detail the apparatus embodiments of the present application with reference to FIG. 7 to FIG. 9. It should be understood that the description of the apparatus embodiments corresponds to the description of the method embodiments. Therefore, for parts that are not described in detail, reference may be made to the foregoing method embodiments.

FIG. 7 is a schematic block diagram of an apparatus for wireless communication according to an embodiment of the present application. The apparatus 700 may be any one of the first terminal devices described above. The apparatus 700 shown in FIG. 7 includes a first communications module 710 and a second communications module 720.

The first communications module 710 may be configured to receive a first wake-up signal, where the first wake-up signal is used to wake up a second communications module.

The second communications module 720 may be configured to determine, based on first information, a first paging occasion for performing paging detection. The first wake-up signal is received by using the first communications module, the paging detection is performed by the second communications module, and the first information includes a reception occasion of the first wake-up signal and/or a load of a serving cell where the first terminal device is located.

Optionally, the first information includes the reception occasion of the first wake-up signal, and the first paging occasion is determined based on the reception occasion of the first wake-up signal and a first paging time window.

Optionally, in a case that the reception occasion of the first wake-up signal is before the first paging time window, the first paging occasion is within the first paging time window; and in a case that the reception occasion of the first wake-up signal is within the first paging time window, the first paging occasion is within the first paging time window or a second paging time window, where the second paging time window is a next time window adjacent to the first paging time window.

Optionally, a first paging frame where the first paging occasion is located belongs to a first type of paging frame, and a time domain location of the first type of paging frame is related to an occasion in which the terminal device receives a wake-up signal.

Optionally, the first information includes the reception occasion of the first wake-up signal, and the first paging frame is determined based on a system frame corresponding to the reception occasion of the first wake-up signal, or the first paging occasion is determined based on a slot corresponding to the reception occasion of the first wake-up signal.

Optionally, the first information includes a load of the serving cell where the first terminal device is located, and the load is related to one or more of the following information: a maximum quantity of paging requests for the serving cell; a current quantity of paging requests for the serving cell; or a service type of the serving cell.

Optionally, a first paging frame where the first paging occasion is located belongs to a second type of paging frame, a quantity of paging occasions included in the second type of paging frame is determined based on a load of the serving cell in a first time period, and an index of the first paging occasion is determined based on a quantity of paging occasions included in the first paging frame.

Optionally, the index iₛ of the first paging occasion is:

$${i}_{s} = floor ( {UE}_{ID} / N ) mod {Ns}^{′} .$$

In which, UE_{ID} denotes an identity of the first terminal device, N denotes a quantity of paging frames within one period, and Ns′ denotes the quantity of paging occasions included in the first paging frame.

Optionally, a first paging frame where the first paging occasion is located belongs to a third type of paging frame, the third type of paging frame is determined based on static configuration of the serving cell, and an index iₛ of the first paging occasion is:

$${i}_{s} = floor ( {UE}_{ID} / N ) mod ( δ \times Ns ) .$$

In which, UE_{ID} denotes an identity of the first terminal device, N denotes a quantity of paging frames within one period, Ns denotes a quantity of paging occasions in the third type of paging frame, and δ denotes an adjustment factor related to the load of the serving cell.

Optionally, the first information further includes switching time of the second communications module, the first paging occasion is one of a plurality of paging occasions, the plurality of paging occasions are located after a first time domain location, and the first time domain location is determined based on the reception occasion of the first wake-up signal and the switching time.

FIG. 8 is a schematic block diagram of another apparatus for wireless communication according to an embodiment of the present application. The apparatus 800 may be any one of the network devices described above. The apparatus 800 shown in FIG. 8 includes a transmitting module 810 and a determining module 820.

The transmitting module 810 may be configured to transmit a first wake-up signal to a first terminal device, where the first wake-up signal is used to wake up a second communications module of the first terminal device.

The determining module 820 may be configured to determine, based on first information, a first paging occasion for transmitting a paging message to the first terminal device. The first terminal device includes a first communications module and the second communications module, the first wake-up signal is received by using the first communications module, the paging message is detected by the second communications module, and the first information includes a reception occasion of the first wake-up signal and/or a load of a serving cell where the first terminal device is located.

Optionally, the first information includes the reception occasion of the first wake-up signal, and the first paging occasion is determined based on the reception occasion of the first wake-up signal and a first paging time window.

Optionally, in a case that the reception occasion of the first wake-up signal is before the first paging time window, the first paging occasion is within the first paging time window; and in a case that the reception occasion of the first wake-up signal is within the first paging time window, the first paging occasion is within the first paging time window or a second paging time window, where the second paging time window is a next time window adjacent to the first paging time window.

Optionally, a first paging frame where the first paging occasion is located belongs to a first type of paging frame, and a time domain location of the first type of paging frame is related to an occasion in which the terminal device receives a wake-up signal.

Optionally, the first information includes the reception occasion of the first wake-up signal, and the first paging frame is determined based on a system frame corresponding to the reception occasion of the first wake-up signal, or the first paging occasion is determined based on a slot corresponding to the reception occasion of the first wake-up signal.

Optionally, the first information includes the load of the serving cell where the first terminal device is located, and the load is related to one or more of the following information: a maximum quantity of paging requests for the serving cell; a current quantity of paging requests for the serving cell; or a service type of the serving cell.

Optionally, a first paging frame where the first paging occasion is located belongs to a second type of paging frame, a quantity of paging occasions included in the second type of paging frame is determined based on a load of the serving cell in a first time period, and an index of the first paging occasion is determined based on a quantity of paging occasions included in the first paging frame.

Optionally, the index iₛ of the first paging occasion is:

$${i}_{s} = floor ( {UE}_{ID} / N ) mod {Ns}^{′} .$$

In which, UE_{ID} denotes an identity of the first terminal device, N denotes a quantity of paging frames within one period, and Ns′ denotes the quantity of paging occasions included in the first paging frame.

Optionally, a first paging frame where the first paging occasion is located belongs to a third type of paging frame, the third type of paging frame is determined based on static configuration of the serving cell, and an index iₛ of the first paging occasion is:

$${i}_{s} = floor ( {UE}_{ID} / N ) mod ( δ \times Ns ) .$$

In which, UE_{ID} denotes an identity of the first terminal device, N denotes a quantity of paging frames within one period, Ns denotes a quantity of paging occasions in the third type of paging frame, and δ denotes an adjustment factor related to the load of the serving cell.

Optionally, the first information further includes switching time of the second communications module, the first paging occasion is one of a plurality of paging occasions, the plurality of paging occasions are located after a first time domain location, and the first time domain location is determined based on the reception occasion of the first wake-up signal and the switching time.

FIG. 9 is a schematic structural diagram of a communications apparatus according to an embodiment of the present application. Dashed lines in FIG. 9 indicate that a unit or module is optional. The apparatus 900 may be configured to implement the methods described in the foregoing method embodiments. The apparatus 900 may be a chip, a terminal device, or a network device.

The apparatus 900 may include one or more processors 910. The processor 910 may support the apparatus 900 in implementing the methods described in the foregoing method embodiments. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program, and the program may be executed by the processor 910, so that the processor 910 executes the method described in the foregoing method embodiment. The memory 920 may be independent of or integrated into the processor 910.

The apparatus 900 may further include a transceiver 930. The processor 910 may communicate with another device or chip by using the transceiver 930. For example, the processor 910 may transmit data to and receive data from another device or chip by using the transceiver 930.

An embodiment of the present application further provides a computer-readable storage medium for storing a program. The computer-readable storage medium may be applied to the terminal device or the network device provided in embodiments of the present application, and the program causes a computer to execute the method executed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

An embodiment of the present application further provides a computer program product. The computer program product includes a program. The computer program product may be applied to the terminal device or the network device provided in embodiments of the present application, and the program causes a computer to execute the methods executed by the terminal device or the network device in various embodiments of the present application.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to the terminal device or the network device provided in embodiments of the present application, and the computer program causes a computer to execute the methods executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being predefined may refer to being defined in a protocol.

In embodiments of the present application, the “protocol” may indicate a standard protocol in the communication field, which may include, for example, an LTE protocol, an NR protocol, and a related protocol applied to a future communications system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, wherein the method is applied to a first terminal device that comprises a first communications module and a second communications module, and the method comprises:
receiving a first wake-up signal, wherein the first wake-up signal is used to wake up the second communications module; and
determining, based on first information, a first paging occasion for performing paging detection,
wherein the first wake-up signal is received by using the first communications module, the paging detection is performed by the second communications module, and the first information comprises a reception occasion of the first wake-up signal.

2. The method according to claim 1, wherein the first information comprises the reception occasion of the first wake-up signal, and the first paging occasion is determined based on the reception occasion of the first wake-up signal and a first paging time window.

3. The method according to claim 2, wherein in a case that the reception occasion of the first wake-up signal is before the first paging time window, the first paging occasion is within the first paging time window; or in a case that the reception occasion of the first wake-up signal is within the first paging time window, the first paging occasion is within the first paging time window or a second paging time window, wherein the second paging time window is a next time window adjacent to the first paging time window.

4. The method according to claim 1, wherein a first paging frame where the first paging occasion is located belongs to a first type of paging frame, and a time domain location of the first type of paging frame is related to an occasion at which the first terminal device receives a wake-up signal.

5. The method according to claim 4, wherein the first information comprises the reception occasion of the first wake-up signal, and the first paging frame is determined based on a system frame corresponding to the reception occasion of the first wake-up signal, or the first paging occasion is determined based on a slot corresponding to the reception occasion of the first wake-up signal.

6. The method according to claim 1, wherein the first information comprises a load of a serving cell where the first terminal device is located, and the load is related to one or more of following information:
a maximum quantity of paging requests for the serving cell;
a current quantity of paging requests for the serving cell; or
a service type of the serving cell.

7. The method according to claim 6, wherein a first paging frame where the first paging occasion is located belongs to a second type of paging frame, a quantity of paging occasions comprised in the second type of paging frame is determined based on a load of the serving cell in a first time period, and an index of the first paging occasion is determined based on a quantity of paging occasions comprised in the first paging frame.

8. The method according to claim 7, wherein an index iₛ of the first paging occasion is:
$${i}_{s} = floor ( {UE}_{ID} / N ) mod {Ns}^{′} ,$$
wherein UE_{ID} denotes an identity of the first terminal device, N denotes a quantity of paging frames within one period, and Ns′ denotes the quantity of paging occasions comprised in the first paging frame.

9. The method according to claim 6, wherein a first paging frame where the first paging occasion is located belongs to a third type of paging frame, the third type of paging frame is determined based on static configuration of the serving cell, and an index iₛ of the first paging occasion is:
$${i}_{s} = floor ( {UE}_{ID} / N ) mod ( δ \times Ns ) ,$$
wherein UE_{ID} denotes an identity of the first terminal device, N denotes a quantity of paging frames within one period, Ns denotes a quantity of paging occasions in the third type of paging frame, and δ denotes an adjustment factor related to the load of the serving cell.

10. The method according to claim 1, wherein the first information further comprises switching time of the second communications module, the first paging occasion is one of a plurality of paging occasions, the plurality of paging occasions are located after a first time domain location, and the first time domain location is determined based on the reception occasion of the first wake-up signal and the switching time.

11. A method for wireless communication, comprising:
transmitting a first wake-up signal to a first terminal device, wherein the first wake-up signal is used to wake up a second communications module of the first terminal device; and
determining, based on first information, a first paging occasion for transmitting a paging message to the first terminal device,
wherein the first terminal device comprises a first communications module and the second communications module, the first wake-up signal is received by using the first communications module, the paging message is detected by the second communications module, and the first information comprises a reception occasion of the first wake-up signal.

12. A first terminal device, comprising:
a first communications module;
a second communications module;
at least one processor; and
one or more non-transitory computer-readable storage media coupled to the at least one processor and storing programming instructions for execution by the at least one processor, wherein the programming instructions, when executed, cause the first terminal device to perform operations comprising:
receiving a first wake-up signal, wherein the first wake-up signal is used to wake up the second communications module; and
determining, based on first information, a first paging occasion for performing paging detection,
wherein the first wake-up signal is received by using the first communications module, the paging detection is performed by the second communications module, and the first information comprises a reception occasion of the first wake-up signal.

13. The first terminal device according to claim 12, wherein the first information comprises the reception occasion of the first wake-up signal, and the first paging occasion is determined based on the reception occasion of the first wake-up signal and a first paging time window.

14. The first terminal device according to claim 13, wherein in a case that the reception occasion of the first wake-up signal is before the first paging time window, the first paging occasion is within the first paging time window; or in a case that the reception occasion of the first wake-up signal is within the first paging time window, the first paging occasion is within the first paging time window or a second paging time window, wherein the second paging time window is a next time window adjacent to the first paging time window.

15. The first terminal device according to claim 12, wherein a first paging frame where the first paging occasion is located belongs to a first type of paging frame, and a time domain location of the first type of paging frame is related to an occasion at which the first terminal device receives a wake-up signal.

16. The first terminal device according to claim 15, wherein the first information comprises the reception occasion of the first wake-up signal, and the first paging frame is determined based on a system frame corresponding to the reception occasion of the first wake-up signal, or the first paging occasion is determined based on a slot corresponding to the reception occasion of the first wake-up signal.

17. The first terminal device according to claim 12, wherein the first information comprises a load of a serving cell where the first terminal device is located, and the load is related to one or more of following information:
a maximum quantity of paging requests for the serving cell;
a current quantity of paging requests for the serving cell; or
a service type of the serving cell.

18. The first terminal device according to claim 17, wherein a first paging frame where the first paging occasion is located belongs to a second type of paging frame, a quantity of paging occasions comprised in the second type of paging frame is determined based on a load of the serving cell in a first time period, and an index of the first paging occasion is determined based on a quantity of paging occasions comprised in the first paging frame.

19. The first terminal device according to claim 18, wherein the index iₛ of the first paging occasion is:
$${i}_{s} = floor ( {UE}_{ID} / N ) mod {Ns}^{′} ,$$
wherein UE_{ID} denotes an identity of the first terminal device, N denotes a quantity of paging frames within one period, and Ns′ denotes the quantity of paging occasions comprised in the first paging frame.

20. The first terminal device according to claim 17, wherein a first paging frame where the first paging occasion is located belongs to a third type of paging frame, the third type of paging frame is determined based on static configuration of the serving cell, and an index iₛ of the first paging occasion is:
$${i}_{s} = floor ( {UE}_{ID} / N ) mod ( δ \times Ns ) ,$$
wherein UE_{ID} denotes an identity of the first terminal device, N denotes a quantity of paging frames within one period, Ns denotes a quantity of paging occasions in the third type of paging frame, and δ denotes an adjustment factor related to the load of the serving cell.
